(19) United States
(12) Patent Application Publication
(10) Pub. No.: US 2022/0219071 A1
(43) Pub. Date: Jul. 14, 2022

(54) PRIME BOARD

(71) Applicant: Laurel DRAKE, (US)

(72) Inventors: Laurel DRAKE, Harpers Ferry, WV (US); Daniel Joseph SHANKMAN, Tuscaloosa, AL (US)

(21) Appl. No.: 17/573,584

(22) Filed: Jan. 11, 2022

Related U.S. Application Data
(60) Provisional application No. 63/135,955, filed on Jan. 11, 2021.

(51) Int. Cl. A63F 3/04

(52) U.S. Cl. CPC A63F 3/0415; A63F 2003/0418

(57) ABSTRACT

A method of using a math manipulative configured to help a user organize a breakdown of a given number into its prime factors, the method including using a board comprising columns, each column assigned to a different prime number and configured to accommodate chips, the board giving a visual picture of the prime factors of the given number to the user, and adding the chips in each of the columns by the user, wherein a number of chip added in each of the columns is the number of times the prime number corresponding to each column is a prime factor of the given number.

### BACKGROUND

Currently, students may be taught how to find the greatest common factor (GCF) and the least common multiple (LCM) for two or more numbers using paper and pencil methods. Such methods may not provide a bridge to student understanding of how the prime factorization of the numbers is used to form the GCF and the LCM.

The above information disclosed in this Background section is only for enhancement of understanding of the background of the inventive concept, and, therefore, it may contain information that does not form the prior art that is already known in this country to a person of ordinary skill in the art.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1, FIG. 2, FIG. 3, FIG. 4, FIG. 5, FIG. 6, FIG. 7, FIG. 8, FIG. 9, FIG. 10, FIG. 11, and FIG. 12 are views showing a prime board according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. Also, like reference numerals denote like elements.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

According to exemplary embodiments, a prime board is a “math manipulative” that may be used to represent most integers up to a several-digit number. The prime board shows a number in terms of its prime factorization. If two or more numbers are placed on the prime board (using a different color for each number), a student may see the factors displayed and find the greatest common factor (GCF) and the least common multiple (LCM) of the given numbers.

The uses of the prime board may be to represent an integer by its prime factors, load the factors of two or more numbers onto the board and determine their GCF and LCM, play games like “guess my number” where a player loads a number onto his/her board and a second player tries to find the number by asking yes/no questions about the number and from the answers builds the number on his/her own board.

There is no manipulative used in schools to teach GCF and LCM. Typically, students use a paper and pencil method. Elementary math and properties of numbers can be difficult conceptually. With the prime board, students have a tactile and visual representation of a number and can see its factors laid out. The method for finding the LCM uses the properties of a common multiple so that the student sees why the resulting answer is the least common multiple. The factors not used for the LCM are common to both numbers so their product becomes the greatest common factor. The student will understand number properties at a deeper level than before while using the prime board to perform these operations.

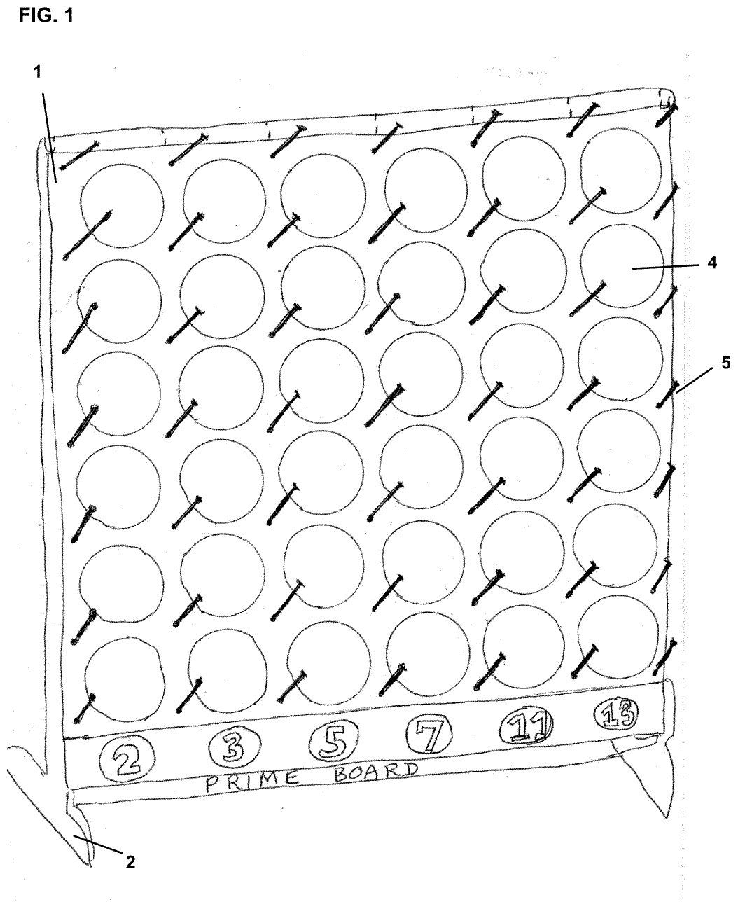

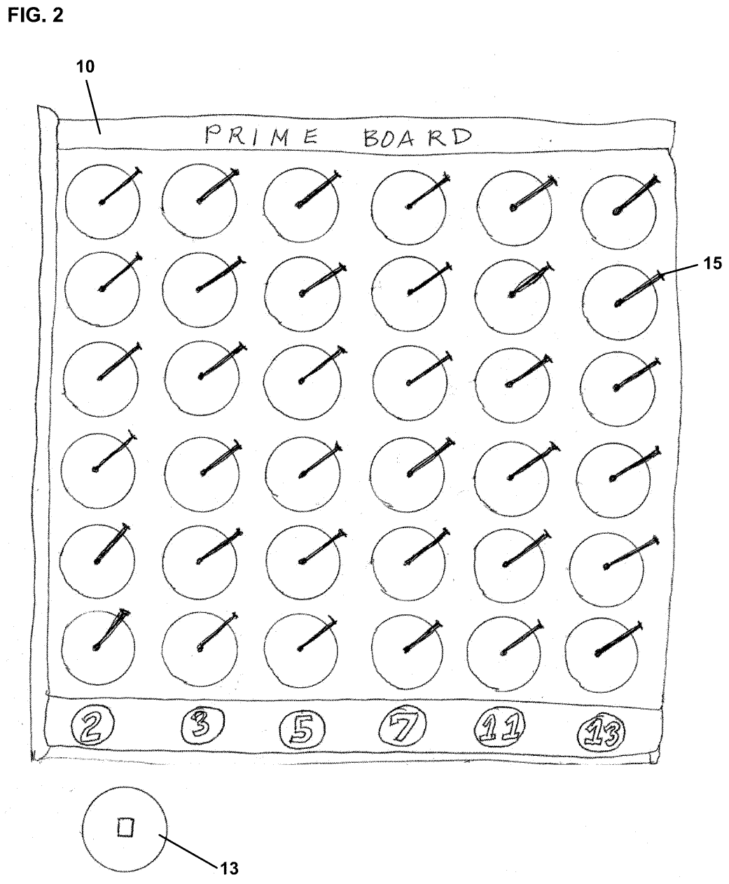

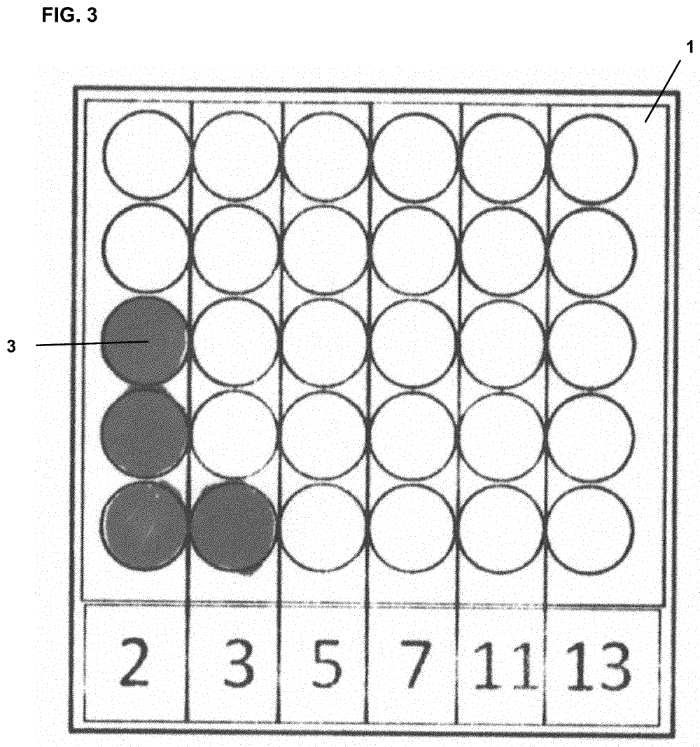

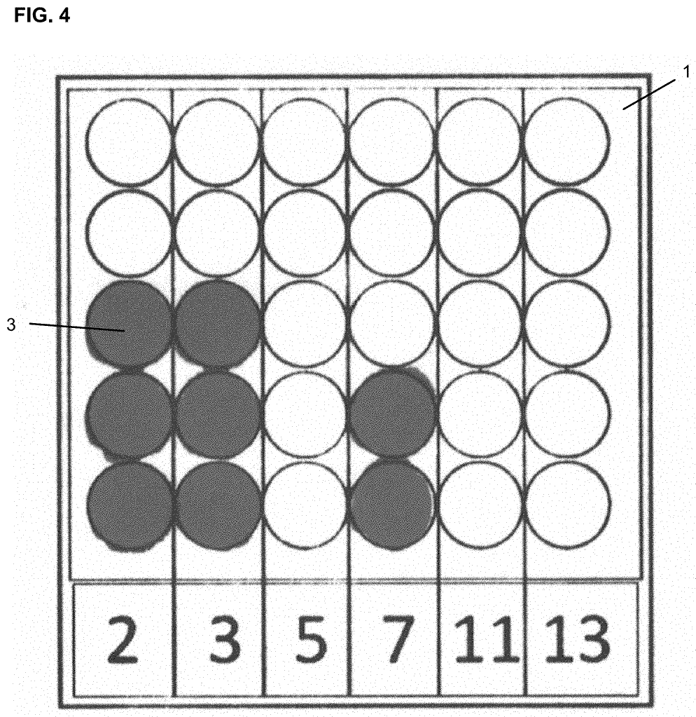

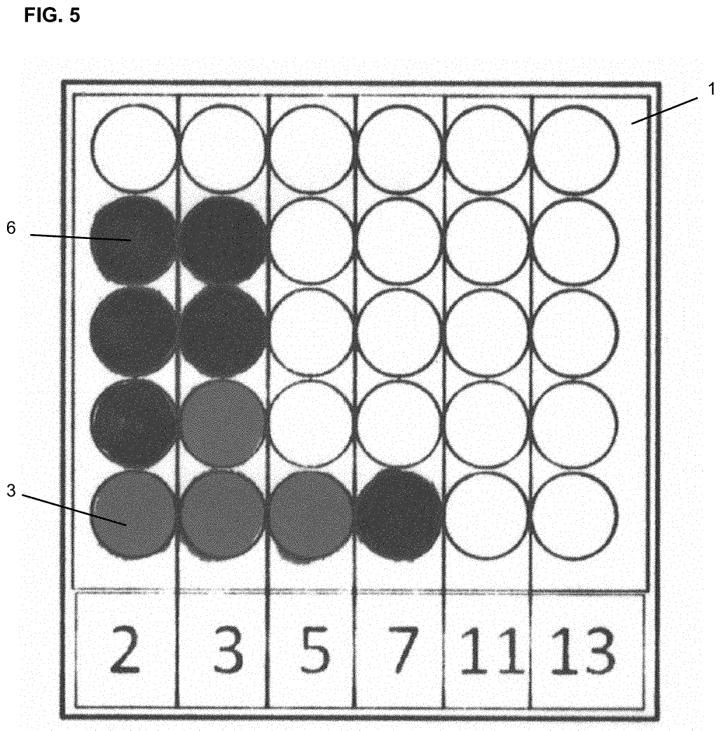

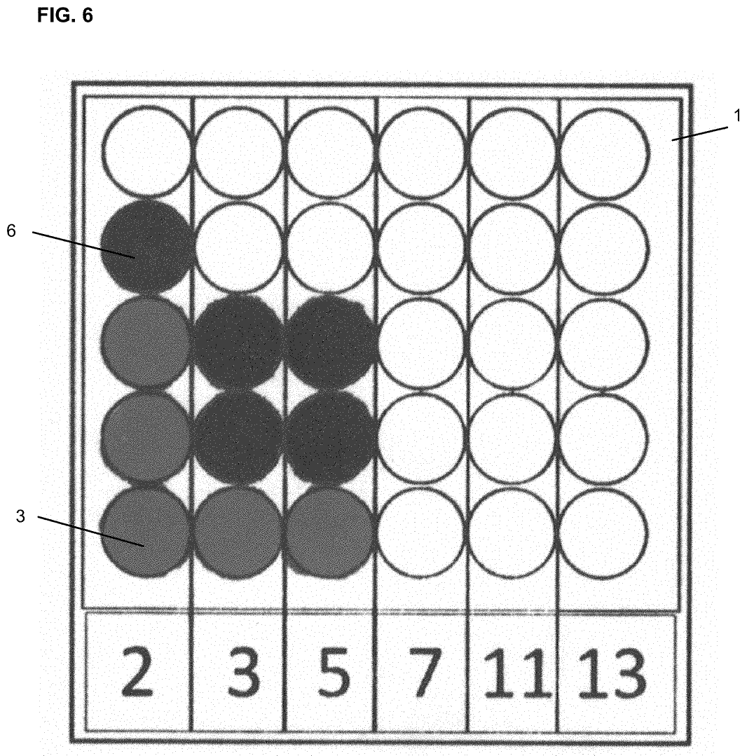

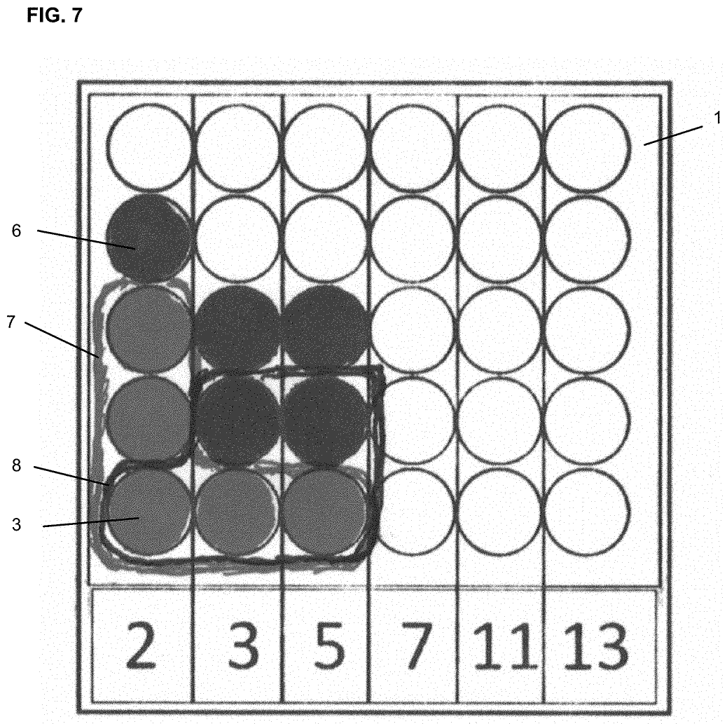

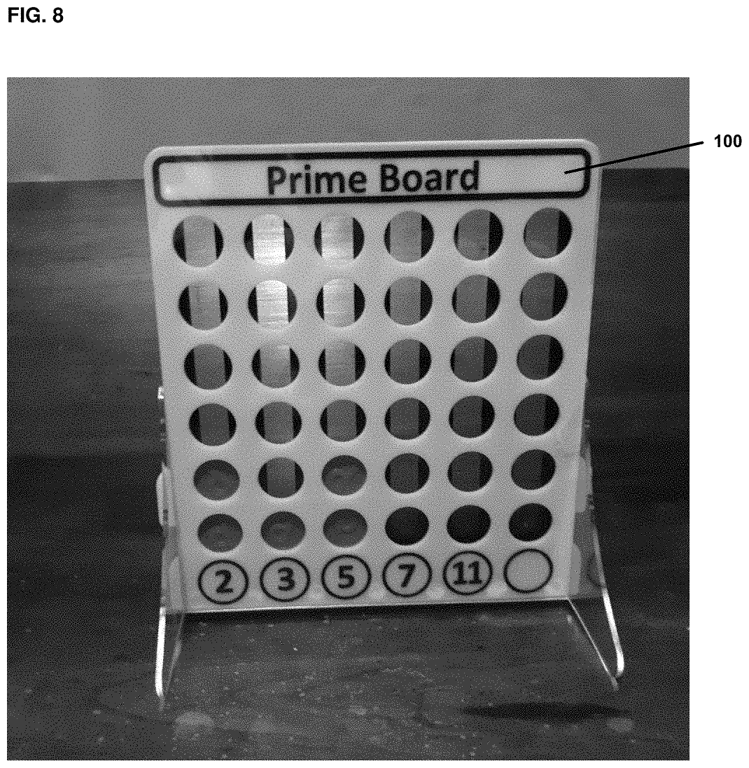

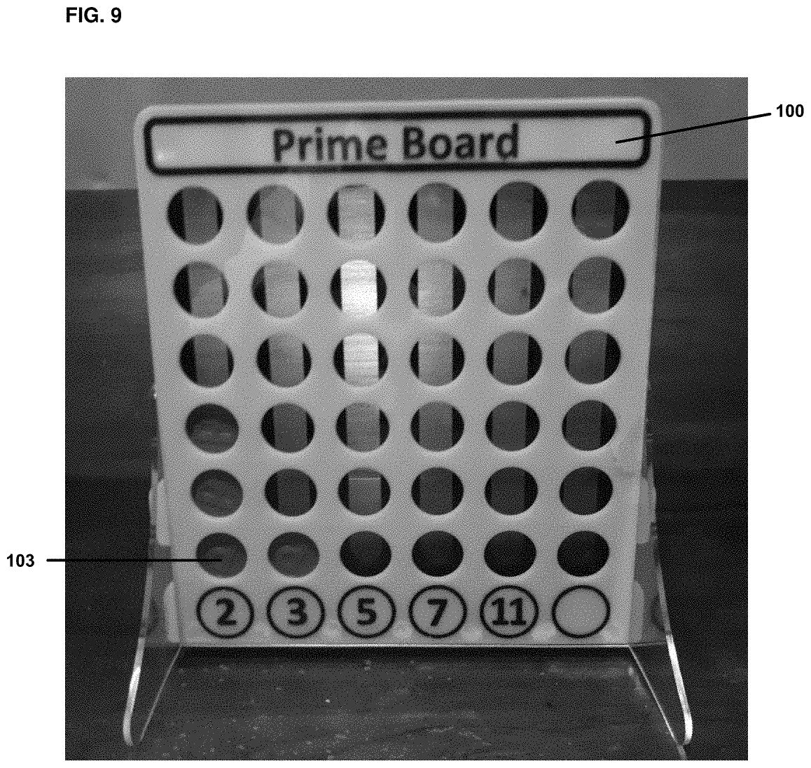

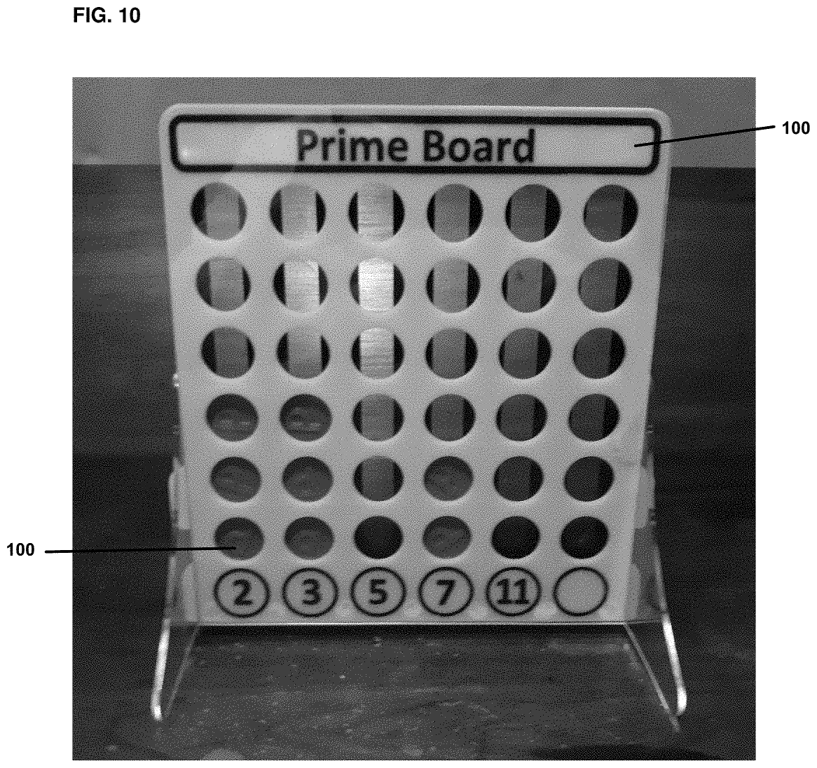

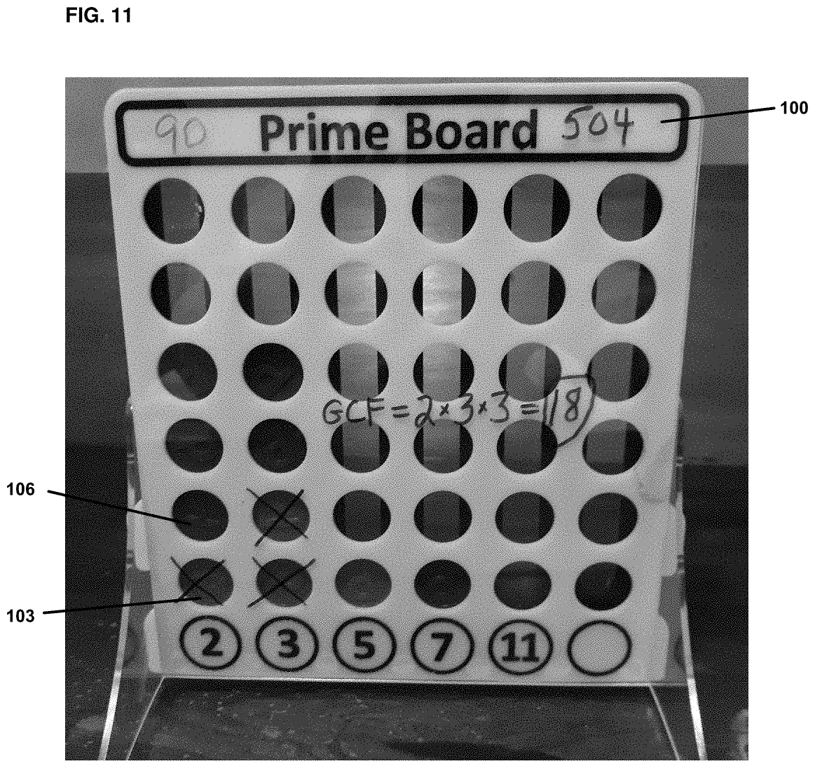

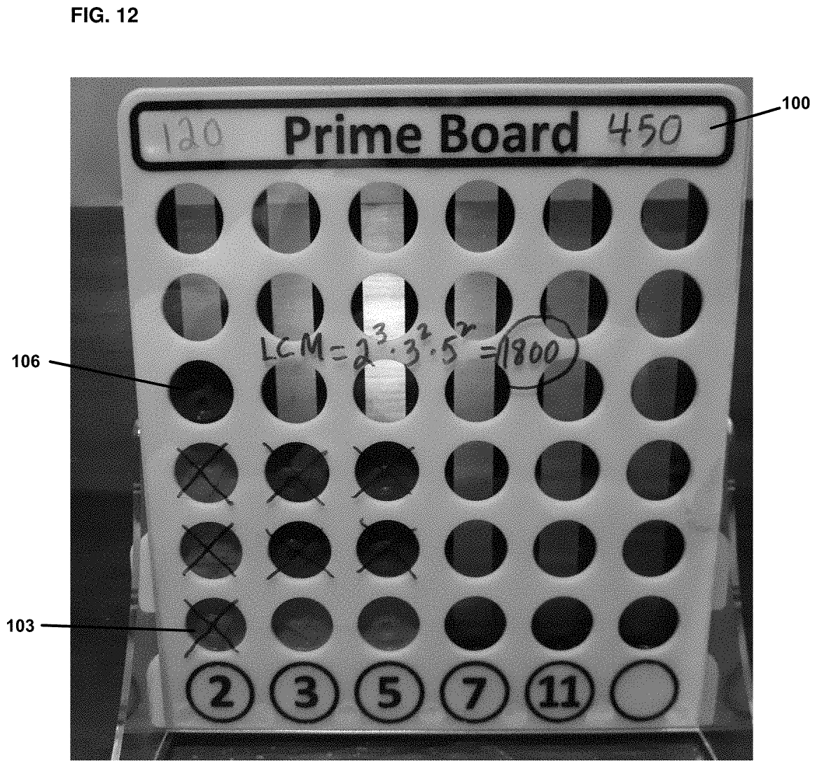

According to an exemplary embodiment as shown in FIG. 1, a vertical prime board 1 sits on a base 2 so that the board 1 is perpendicular to a surface such as a desk or table that the base 2 sits on. Chips (not shown) are put into slots in the board 1 from the top thereof, and slide down in the column in which they are placed. Slots 4 in the board 1 are “open” in that any chips inserted in the column can be seen in these open slots 4. A group of chips can be grouped using pegs 5 on the board 1, using a cover such as a rubber band (not shown).

Twenty yellow chips, twenty red chips, and twenty blue chips are used with the prime board. Labels may be affixed to the top of a chip. Such a label can be used to indicate a prime number that is larger than thirteen. In this way, the prime board can represent numbers whose prime factors are larger than thirteen.

According to an exemplary embodiment, as shown in FIG. 2, a horizontal prime board 10 rests on a surface such as a desk so that the board 10 is parallel with surface it sits on. Chips 13, which may be round with a hole in the middle of them, are placed on pegs 15. A group of chips 13 can be grouped using the pegs 15 on the board 10, using a rubber band or yarn or a cover of some kind (not shown). The prime board 10 may be substantially the same as the prime board 1 described herein, and the disclosure with respect to the prime board 1 is incorporated by reference into the disclosure of the prime board 10, and any repeated disclosure may be omitted for the sake of brevity. Likewise, the disclosure with respect to the prime board 10 is incorporated by reference into the disclosure of the prime board 1.

I. Representation of an Integer by its Prime Factors

Every whole number like 24 or 150 or 10,584, can be written uniquely as the product of its prime factors. The prime board 1 can be used to give a visual and tactile representation of the prime factorization of a number. For example, 24=2*2*2*3 or 2³*3. To represent this number on the prime board, one chip 3 is used for each prime factor. Three chips 3 are loaded in the “2” column and one chip 3 is loaded in the “3” column. The other columns are blank because those factors are not part of the prime factorization of 24. Thus, the representation of 24 on the prime board 1 is shown in FIG. 3.

Another example is the number 10,584, which can be factored as 2³*3³*7², as shown in FIG. 4. The prime board 1 represents this number with three chips in the “2” column, three chips in the “3” column, and two chips in the “7” column. The other columns are empty because those factors are not part of the prime factorization of 10,584.

II. Finding the Greatest Common Factor of Two or More Numbers

The prime board can used to find the Greatest Common Factor (GCF) of two or more numbers. Each number is loaded onto the prime board using a different color for each number. The definition of GCF tells us that we should look for factors in common from the factors of each number. Starting with the “2” column, it is observed how many “2”s are in common. Then we go to the “3” column, the “5” column, and so on, noticing the factors in common. The product of all of these common factors is the GCF of the numbers.

For example, using the prime board, one can find the GCF of 90 and 504. As shown in FIG. 5, the prime factorization of 90 (90=2*3²*5) is used, and the factors are loaded into the prime board 1 with red chips 3. Then we do the same with 504 (504=2³*3²*7) but blue chips 6 are used to load these factors into the prime board.

Then factors in common between the prime factors of 90 (red chips) and the prime factors of 504 (blue chips) are identified. The different color chips allow distinguishing which prime factors belong to which of the two numbers. As shown in FIG. 5, the “2” column has three blue chips 6 and one red chip 3. Each chip in the “2” column represents the number “2” whether it is red or blue. The chips in the “2” column show that there is one “2” in common. The “3” column has two blue chips 6 and two red chips 3, so that the two numbers have two “3”s in common. The “5” column has one red chip 3 and no blue chips 6, so there are no “5”s in common. The “7” column has one blue chip 6 and no red chips 3 so that there are no “7”s in common. The chips found to be in common (one “2” and two “3” s) represent factors that are common to both 90 and 504. Thus, the GCF of 90 and 504 is 2*3*3=18. In this way, the student has used a tactile and visual method to see the factors of 90 and 504 displayed by red chips and blue chips and used the notion of what is common between the factors, one prime factor at a time, to find the product of common prime factors, the GCF.

This procedure can be generalized to find the GCF of three numbers by using chips of a third color to denote the factors of the third number and following the same method as described above with respect to FIG. 5.

III. Finding the Least Common Multiple of Two Numbers and their Greatest Common Factor.

The prime board can be used to find the least common multiple (LCM) of two numbers and their greatest common factor (GCF). Each number is loaded onto the prime board using a different color for each number. The LCM of two numbers is the smallest number that contains the prime factors of both numbers. The student can “construct” the LCM from the display of all of the factors on the prime board. The student can encircle all of the chips from one of the numbers (where each chip represents a prime factor of the number) with a rubber band or other cover. Then the student would use a second rubber band or cover to encircle chips (i.e. factors) from the second number that were not already present in the first encircled area. The product of the factors represented by chips inside both encircled areas is the LCM of the two numbers. The product of the factors represented by chips outside the encircled areas is the GCF.

For example, the prime board can be used to find the LCM of 120 and 450. The prime factors of 120 (120=2³*3*5) are loaded into the prime board 1 using red chips 3, as shown in FIG. 6. Then the prime factors of 450 (450=2*3²*5²) are loaded into the prime board 1 using blue chips 6.

One of the properties of the LCM of two numbers is that it is the smallest number that contains the prime factors of both numbers. Indicators, such as rubber bands or yarn or some other type of cover, are used to enclose the factors that when multiplied together give the LCM of the two numbers. Since the smallest possible product is desired, the number of factors inside the rubber bands should be as few as possible, but must still contain the factors of 120 and the factors of 450.

Accordingly, a red rubber band 7 is placed around all of the factors that are indicated by red chips 3 (i.e., the factors that make 120). Then all of the factors of 450 must also be part of the LCM and we will use a blue rubber band 8 to encircle them. However, instead of encircling all of the blue chips, we can omit any blue chip that has a red chip in the same column and encircle the red chip instead (all chips in the same column represent the same prime factor). In this way, we are making the smallest possible product of prime factors from 120 and 450 that still has all of the prime factors of 120 and of 450.

Looking at the blue chips 6 (i.e., the factors of 450), the factors of 450 consist of one “2”, two “3” s, and two “5” s. A blue rubber band 8 is placed around a red chip in the “2” column (taking the place of the blue chip in the same column), a red chip and a blue chip in the “3” column (since two “3”s are needed and there is only one red “3” available) and a red chip and blue chip in the “5” column (since two “5”s are needed, and there is only one red “5” available), as shown in FIG. 7. If the numbers represented by chips that are inside both rubber bands are multiplied, the product is the LCM of 120 and 450. Thus, the LCM=2³*3²*5²=1800. This method also allows obtaining the GCF of 120 and 450. Some chips have been left outside the rubber bands. Blue chips 6 indicating each of “2”, “3” and “5” have been left out in FIG. 7. The product of factors represented by the chips outside the rubber bands is the GCF of 120 and 450. Thus the GCF=2*3*5=30.

Why do the chips outside the rubber bands give us the GCF? The reason some blue chips 6 are left outside of the rubber bands is that they represent factors for which a red chip was substituted for the blue chip (this happens each time there is a factor common to both 120 and 450). For example, the blue “2”, the blue “3” and the blue “5” were all left outside the blue rubber band 8 in FIG. 7 because red chips 3 were substituted for each of these. By definition, the GCF of two numbers is the product of the prime factors common to both numbers, which, not coincidently, are exactly the factors left outside the rubber bands.

IV. Playing “Guess My Number?”

In this two-player game, each player has a prime board. Player A loads the prime factors of a number onto her prime board and keeps it hidden. Person B asks yes/no questions to try to determine Player A's number. As Player B obtains information about the number, he can start building this number on his own board. For example, he could ask if the number is an even number. If the answer is “yes”, then he would put a chip in the “2” column to represent a factor of “2” in the number. If the answer is “no”, he knows that the “2” column will be blank. The game is finished when Player B guesses the right number (Player B wins) or when 20 questions have been asked with no correct guess (Player A wins).

Playing the Board Game “Prime Universe”

In this game, players advance on a path around the board. Along the way they will draw cards that give them tasks to do in order to earn items. The task would be to answer questions about the prime factorization of a number, the greatest common factor of two or more numbers, or the least common multiple of two numbers. They must use the prime board to answer the question. The winner is the first person who advances to the last space with the required earned items.

A prime board 100 according to an exemplary embodiment is shown in FIG. 8, FIG. 9, FIG. 10, FIG. 11 and FIG. 12. The prime board 100 may be substantially the same as the prime board 1 and prime board 10 described above with respect to FIGS. 1 through 7 of the present application, and the disclosure thereof is incorporated herein by reference, and any repeated disclosure may be omitted for the sake of brevity. Likewise, the description herein with respect to FIGS. 8-12 is incorporated by reference in the exemplary embodiments shown with respect to FIGS. 1-7.

In FIG. 8, the number 300 has been represented using its prime factors. Since 300=2²*3*5², its representation on the prime board uses two chips in the “2” column, one chip in the “3” column, and two chips in the “5” column. Each chip is the representation of a prime factor of 300.

Up to fifteen yellow chips, fifteen red chips, and fifteen blue chips can be used with the prime board 100. Labels may be affixed to the top of a chip. Such a label can be used to indicate a prime number that is larger than eleven. In this way, the prime board 100 can represent numbers whose prime factors are larger than eleven.

For example, using the prime board 100, one can find the GCF of 90 and 504. As shown in FIG. 11, the prime factorization of 90 (90=2*3²*5) is displayed with red chips; each factor of 90 is represented using a red chip 103. Then we do the same with 504 (504=2³*3²*7) but blue chips 106 are used to load these factors into the prime board 100.

As can be seen in FIG. 11, the surface of the prime board 100 can be written on, such as using a wet-erase marker as in the present exemplary embodiment. The chips that are found to be in common between the red chips 103 and the blue chips 106 are marked with an “X”. For this example, one chip in the “2” column and two chips in the “3” column are marked with an “X”. The calculation of the greatest common factor can also be done on the prime board 100. The student uses the factors that have been marked in common and can show their product to find the GCF. In this example, the GCF is found to be the product of 2, 3 and 3, so the product is 18.

The prime board 100 can be used to find the least common multiple (LCM) of two numbers and their greatest common factor (GCF). Each number is loaded onto the prime board 100 using a different color for each number. The LCM of two numbers is the smallest number that contains the prime factors of both numbers. The student can “construct” the LCM from the display of all of the factors on the prime board 100.

In FIG. 12, the work for finding the LCM of 120 and 450 is shown. The number 120 has been loaded with red chips 103. The number 450 has been loaded with blue chips 106. The student can use a marker on the surface of the prime board to mark factors of the LCM.

For each column in the prime board, the student would count the number of red chips 103 and blue chips 106 in that column and mark all of the chips in the larger group of chips. By choosing the larger group of factors, the student has ensured that the factors of both numbers are going to be included in the LCM. If there are the same number of red chips 103 and blue chips 106 in a column, then the student can mark either group. If there is only one color set of chips in any column, then they should be marked because they are factors of either 120 or 450 so they should be part of the LCM by definition of LCM. When all of the columns have been marked, the product of the marked factors is the LCM. The product of the factors represented by the unmarked chips is the GCF.

One of the properties of the LCM of two numbers is that it is the smallest number that contains the prime factors of both numbers. Since the smallest possible product is desired, we can look at the “2” column to see how to include factors. For this example, there are three red chips 103 (representing 2*2*2=8 as a factor of 120) and one blue chip 106 (representing 2 as a factor of 450). The LCM must contain all of the factors of both 120 and 450, so it must contain the factor 8—therefore, we would mark three chips in the “2” column for later inclusion in the LCM. On the other hand, with the factor 8 included, the factor of 2 (from 450) has automatically been included (from 8=2*2*2). For this reason, we always choose the larger group of factors (from the two colors of chips) in each column.

Accordingly, we mark the group of three red chips 103 in column “2” (since the group of three red chips is larger than the group of one blue chip). We mark the two blue chips 106 in column “3” (since the group of two blue chips 106 is larger than the group of a single red chip 103). We mark the two blue chips 106 in column “5” (since the group of two blue chips 106 is larger than the group of the single red chip 103). In this way, we are marking all of the factors that will make the smallest possible product of prime factors from 120 and 450.

The product of all of the marked chips will be the LCM. Thus, the LCM=2³*3²*5²=1800. For each column, the chips in the larger group of factors (comparing the two groups of colored chips) is marked. In the “2” column, the three red chips 106 are marked with an “X”, since the group of three red chips 103 is larger than the group of a single blue chip 103, and so on. After considering and marking each column, the student could do the computation of the LCM as the product of all of the marked factors on the prime board 100, as can be seen in FIG. 12.

Some chips have not been marked. Chips indicating one each of “2”, “3” and “5” have not been marked in FIG. 12. The product of factors represented by the unmarked chips is the GCF of 120 and 450. Thus the GCF=2*3*5=30. Why do the unmarked chips give us the GCF? The reason some chips are not marked is that they were in a column in which a larger group of that factor was marked from the other of the two numbers (this happens each time there is a factor common to both 120 and 450). By definition, the GCF of two numbers is the product of the prime factors common to both numbers, which, not coincidently, are exactly the unmarked factors.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

1. A game comprising a board, a first chip, and a second chip,
wherein each chip represents an integer, the board is configured to accommodate the first chip and the second chip, and the board is configured to allow a user to determine a greatest common factor or a least common multiple of the integers represented by the first chip and the second chip.

2. A method of using a math manipulative configured to help a user organize a breakdown of a given number into its prime factors, the method comprising:
using a board comprising columns, each column assigned to a different prime number and configured to accommodate chips, the board giving a visual picture of the prime factors of the given number to the user; and
adding the chips in each of the columns by the user, wherein a number of chip added in each of the columns is the number of times the prime number corresponding to each column is a prime factor of the given number.

3. The method of claim 2, wherein using the board further comprises:
loading chips representing the prime factors of two or more given numbers using a different chip color for the prime factors of each of the two or more given number; and
using the properties of the prime factors on display on the board to find a greatest common factor and a least common multiple of those given numbers.
